(19) United States
(12) Patent Application Publication
(10) Pub. No.: US 2008/0199262 A1
(43) Pub. Date: Aug. 21, 2008

(54) Powder Injection Microchip

(75) Inventors: Torsten Vilkner, Greifswald (DE); Andreas Manz, East Molesey (GB)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: IMPERIAL INNOVATIONS LIMITED, London, EN (GB)

(21) Appl. No.: 11/915,047

(22) PCT Filed: May 18, 2006
(86) PCT No.: PCT/GB06/01826

§ 371 Date: Feb. 25, 2008

(30) Foreign Application Priority Data
May 20, 2005 (GB) 0510357.7

(51) Int. Cl. B65G 53/50; G01N 27/00

(52) U.S. Cl. 406/144; 204/600

(57) ABSTRACT

The present invention relates to a powder injection microchip, and a method of injecting powder using said powder injection microchip, wherein the microchip comprises a vibratable member associated with a powder inlet to a powder flow channel, wherein the vibration of the vibratable member allows the interparticle forces within cohesive powders to be overcome, resulting in the fluidisation of the powder. A powder inlet orifice with a dimension restricted relative to a powder flow channel dimension, and at least one gas flow channel in fluid connection with a powder flow channel downstream of a powder inlet orifice, are also disclosed.

The present invention relates to a powder injection microchip for injecting powder components, and a powder injection method.

Powder injection methods are employed in a wide variety of industries, but are particularly important within the pharmaceutical industry. The manufacture of tablets and powders requires the handling of small amounts of dry granular powder compositions. The injection process allows the supply of small amounts of a powder composition when needed. The injection process may additionally feed powder into a mixing process which allows the homogenisation of the drug with one or more additional components. Injections of very small amounts of powder can have other potential applications, for example in an analytical operation that requires the precise weighing of small amounts of powders.

Powder injection microchips have been developed to allow the handling and injection of small amounts of powders. Such a microchip is described in PCT Application No. PCT/GB2004/002718, which is herein incorporated by reference. The microchip described therein comprises a powder inlet in fluid connection with a channel, an outlet, a gas supply inlet for supplying gas to the powder inlet and channel, and a channel in fluid connection with a powder inlet, a gas supply inlet and an outlet. The powder enters the microchip through the powder inlet. The gas supply through the powder inlet results in the fluidisation of the powder in the powder inlet. When the gas supply is reduced, the powder passes into the channel. When the gas supply to the channel is turned on, the powder moves down the channel towards the outlet. Control of the gas supply determines the amount of powder that comes out of the outlet.

However, the use of such apparatus is restricted to non-cohesive powders such as Dibasic Calcium Phosphate (Fujicalin®). Cohesive powders, that is those powders with a Cohesive Bond Number (B_{oc}) of larger than 1, as a general rule, include powders with a particle size of less than 100 μm. Examples include microcrystalline cellulose particles, Lactopress Spraydried and the majority of commonly used pharmaceutical excipients. These powders are difficult to fluidise because of strong inter-particle forces. When the aforementioned apparatus is used to handle cohesive powders, the powder is not sufficiently fluidised by the gas flow, resulting in the formation of blockages within the channels.

Several methods of preventing the blockages created when fine powders flow from small-scale hoppers have been investigated, including gravity flow and pressure assisted flow. However, Kumar, P., Santosa, J. K., Beck, E. & Das, S., 2004 Direct-write deposition of fine powders through miniature hopper-nozzels for multi-material solid freeform fabrication. Rapid Prototyping Journal, 10(1): 14-23, showed that gravity flow was incapable of delivering powders below 63 μm mean diameter, and pressure-assisted flow lead to undesirable phenomena such as spouting or sporadic flow.

The invention is set out in the claims. Because of the provision of a vibratable member, it is possible to overcome the interparticle forces in cohesive powders upon the application of vibration. The temporary reduction of the interparticle forces results in the fluidisation of the powder.

Embodiments of the invention will now be described, by way of example, with reference to the drawings, of which:

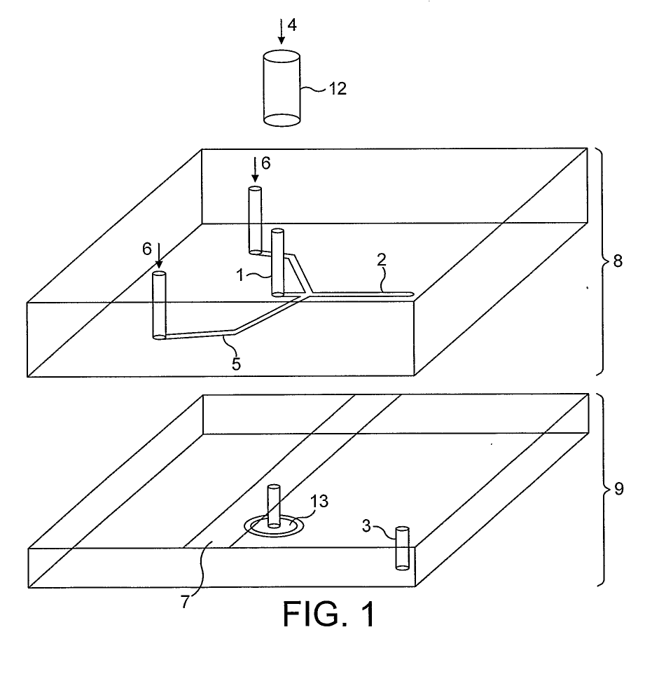

FIG. 1 shows a simplified schematic of the powder injection microchip;

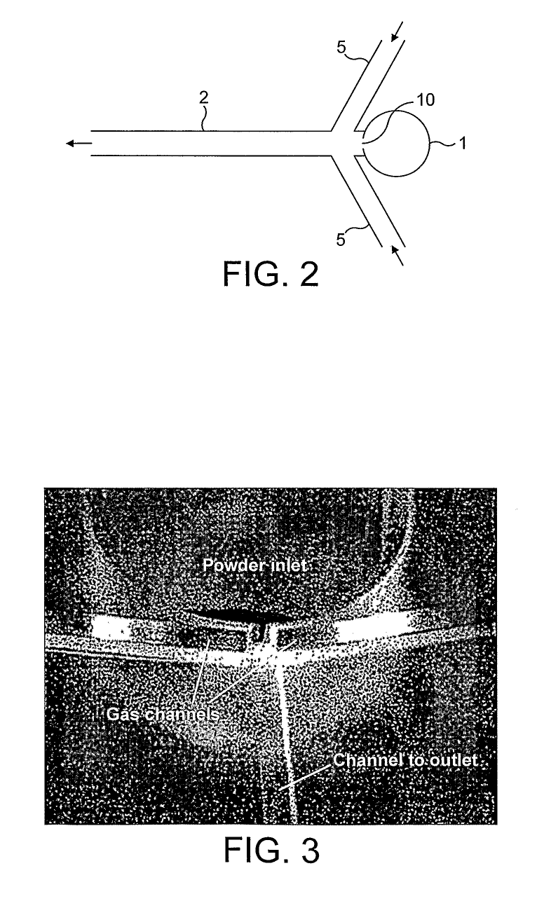

FIG. 2 shows a schematic of the interface between the powder inlet, powder inlet orifice, powder flow channel and gas flow channels, wherein the arrows indicate the direction of gas flow and;

FIG. 3 shows a photograph of the interface between the powder inlet, powder inlet orifice, powder flow channel and gas flow channels.

In the following description, a method and apparatus for injecting a powder using a powder injection microchip comprising a vibratable member associated with powder inlet and/or powder hopper to a powder flow channel are described. For the purposes of explanation, numerous specific details are set fourth to provide a thorough understanding of the present invention. It will be apparent to those skilled in the art that the present invention may be practised without these specific details.

Referring to FIG. 1, the powder injection microchip comprises a powder inlet 1 in fluid connection with a powder flow channel 2, an outlet 3 in fluid connection with the powder flow channel 2; a gas supply inlet 4 for supplying gas to the powder inlet 1; two gas flow channels 5 in fluid connection with the powder flow channel 2; two gas supply inlets 6 for supplying gas to the gas flow channels 5; and a vibratable member 7 associated with the powder inlet 1. A powder hopper 12 is in fluid connection with the powder inlet 1.

The connection between the powder inlet 1 and the powder flow channel 2 defines a powder inlet orifice 10. The powder inlet orifice 10 has a dimension that is restricted relative to a powder flow channel 2 dimension; and is in fluid connection with the powder inlet 1 and the powder flow channel 2. A gas supply inlet 4 to supply gas to the powder inlet 1 is in fluid connection with the powder inlet 1. The powder inlet 1 is in fluid connection with a powder hopper 12. The powder hopper 12 functions as an extension of the powder inlet 1. The use of a powder hopper 12 is not essential to the functioning of the microchip, but allows the storage of a greater volume of powder. Thus, in some instances, the term ‘powder inlet 1’ incorporates the powder hopper 12. The gas supply inlet 4 to supply gas to the powder inlet 1 is in fluid connection with the powder hopper 12. Said gas supply inlet 4 is arranged to provide gas at a flow rate sufficient to push the particles from the powder hopper 12, through the powder inlet 1, through the powder inlet orifice 10 and into the powder flow channel 2 without causing a blockage to form in the powder inlet 1, powder inlet orifice 10 or powder flow channel 2. The arrow in FIG. 1 indicates the direction of movement of the gas introduced via the gas inlet 4, and hence the powder flow direction. The gas flows from the gas supply inlet 4, through the powder hopper 12 and into the powder inlet 1.

The vibratable member 7, in the form of a vibratable foil, is positioned in operable connection with the powder inlet 1 and the powder hopper 12, i.e. so as to cause the vibration of particles of powder at the base of the powder bed in or near the powder inlet 1 and/or the powder hopper 12, when the vibratable member is made to vibrate. In this embodiment, the vibratable foil 7 is positioned downstream of the powder inlet 1 and perpendicular to the powder inlet orifice 10, on the top surface of the bottom plate of the chip 9

The powder injection microchip further comprises a piezoelectric transducer 13 arranged to vibrate the vibratable member 7.

The apparatus further comprises 1^{st} and 2^{nd} gas flow channels 5 in fluid connection with the powder flow channel 2 adjacent to and downstream of the powder inlet orifice 10 in the powder flow direction. Gas supply inlets 6 to supply gas to the gas flow channels 5 are in fluid connection with said gas flow channels 5 and arranged to provide gas with a flow rate sufficient to achieve particle flow through the powder flow channel 2 toward the outlet 3.

In operation, the powder injection microchip, as described above, is used to inject powder, in particular cohesive powder, using a method comprising the steps of transferring the powder to the powder inlet 1 via the powder hopper 12 and causing the vibratable member 7 to vibrate so as to fluidise the powder. In this embodiment, the powder injection microchip is used to inject Microcrystalline Cellulose Particles PH-101.

The sound waves produced by the piezoelectric transducer cause the vibratable foil to vibrate. In this embodiment, the foil vibrates at 1.5 kHz. The vibration of the foil causes the particles of the powder at the base of the powder bed in the powder inlet 1 and/or powder hopper 12 to vibrate such that the interparticle forces between the particles of the cohesive powder are temporarily overcome. The powder thus becomes fluidised.

The gas flow from the gas supply inlet 4 pushes the fluidised powder from the powder hopper 12, through the powder inlet 1, through the powder inlet orifice 10 and into the powder flow channel 2. The narrow diameter of the powder inlet orifice 10 dilutes the flow of particles from the powder inlet 1 into the powder flow channel 2. Thus the flow of particles from the powder inlet 1 into the powder flow channel 2 is more dilute than the flow of particles from the powder hopper 12 into the powder inlet 1. The dilute flow reduces the probability of a blockage forming near the powder inlet orifice 10.

The gas flow from the gas flow channels 5 pushes the fluidised powder down the powder flow channel 2 and through the outlet 3. In this embodiment, the gas flow into the gas flow channels 5 has a gas flow rate of approximately 10 ml.min⁻¹.

Accordingly the invention ensures that when the piezoelectric transducer 13 is switched on, the interparticle forces in the cohesive powder are overcome and the powder is fluidised. The gas flow from the gas supply inlet 4 is therefore able to push the powder from the powder hopper 12 through the powder inlet 1 and the powder inlet orifice 10. The powder therefore proceeds to exit the microchip via the outlet 3. In practise, the mass flow rate in this embodiment was found to be 12.5 mg.min⁻¹.

When the piezoelectric transducer 13 is switched off, or when the vibration of the vibratable foil 7 is in some way prevented, the interparticle forces in the cohesive powder are not overcome and fluidisation of the powder does not occur. The gas flow from the gas supply inlet 4 is unable to push the powder from the powder hopper 12 through the powder inlet 1 and the powder inlet orifice 10. The mass flow rate of powder from the outlet 3 is reduced to zero. Thus the injection of powder from the powder injection microchip can be controlled.

The method can comprise the additional step of sieving the powder before it is introduced to the powder inlet 1 via the powder hopper 12.

The manner in which the various components are selected or fabricated will be apparent to the skilled reader. For example, the powder injection microchip comprises two planar layers, or plates; a top plate 8 and a bottom plate 9. The top plate of the chip 8 and the bottom plate of the chip 9 are tightly connected using any appropriate method. These plates can be made out of any suitable material. Preferably, the plates are made out of Polymethylmethacrylate (PMMA). The dimensions of the chip are 70 mm by 50 mm by 13 mm, wherein the top plate 8 is 10 mm thick and the bottom plate 9 is 3 mm thick.

In the embodiment described, the powder flow channel 2 has a minimum width in excess of twenty times the average particle diameter of the powder in order to prevent channel blockage. In this embodiment, the powder flow channel 2 has a diameter of 600 μm. The powder flow channel 2 is in fluid connection with a powder inlet 1 and defines a powder flow direction. Preferably, the powder inlet and the powder flow channel are positioned at approximately 90° to one another. The powder inlet 1 has a diameter of 6 mm, and its length extends through the width of the top plate of the chip 8 and the bottom plate of the chip 9.

The powder inlet orifice 10 dimension must be smaller than a powder flow channel 2 dimension. Preferably, the ratio of the powder inlet orifice diameter to the powder flow channel 2 diameter is in the range of 1:1.1 to 1:10. More preferably, the ratio of the powder inlet orifice diameter to the powder flow channel 2 diameter is in the range of 1.3 to 1.7. In this embodiment, the ratio of the powder inlet orifice diameter to the powder flow channel 2 diameter is 1.6. The exact size of the powder inlet orifice 10 dimension is selected as a function of the size of particles which comprise the powder for which the powder injection microchip is to be used. For smaller particles, such as Titanium Dioxide and Magnesium Stearate, the powder inlet orifice 10 must be smaller than that for larger particles, such as Lactochem crystals, Aspirin and Paracetemol particles, as if the particles are large, a powder inlet orifice 10 that is too small will become blocked, whereas if the particles are small, a powder inlet orifice 10 that is too large will have a flow velocity that is insufficient to pick up the small particles, which therefore adhere to the bottom wall of the powder flow channel 2 when they exit the powder inlet. In this embodiment the powder inlet orifice has a diameter of 100 μm. The optimum size of the powder inlet orifice 10 dimension may also be affected by, for example, the frequency and amplitude of the vibrations of the vibratable member 7 and the gas flow rates from gas supply inlets 4 and 6.

The gas flow channels 5 are of substantially identical diameter. The gas flow channels 5 of this embodiment both have a diameter of 600 μm. Two symmetrical gas flow channels 5 were chosen in order to allow for an equal and reproducible gas stream in the powder flow channel 2. Alternatively, one gas flow channel may be used. Employing two gas flow channels 5 however, prevents the particles being dragged to one side of the powder flow channel 2, particularly opposite the entrance of the gas flow channel 5, avoiding introduction of additional contact points between the cohesive particles and the powder flow channel 2 walls, and thus slowing down or even stopping the particle flow. The angle between the powder flow channel 2 and the gas flow channels 5 is preferably 100°. This value is chosen as a compromise to achieve two goals; that the gas flow channels 5 should be as close as possible to the powder inlet orifice 10 in order to prevent channel clogging, and that the 600 μm high walls that separate the gas flow channels 5 from the powder inlet 1 on either side of the powder inlet orifice 10 should not break off during manufacture. Of course other angles can be contemplated.

Preferably, the vibratable member 7 comprises a foil member. In this embodiment, the foil comprises a strip of transparent adhesive foil (Tesa® Film, Tesa AG, Hamburg, Germany).

In this embodiment, the piezoelectric transducer 13 comprises a Flying Lead Piezo Transducer, Model No. VSB3EW-0701, Murata Electronics (UK) Ltd, Fleet, UK. Preferably, the piezoelectric transducer 13 is arranged to vibrate in the frequency range of audible sound, taken to be 20 Hz to 20 kHz. Preferably, the piezoelectric transducer 13 is arranged to vibrate in the frequency range of 1.4 to 1.6 kHz. In this embodiment, the piezoelectric transducer 13 is arranged to vibrate at a frequency 1.5 kHz. This has been found to be the preferred frequency to maximise the mass flow rate of Microcrystalline cellulose PH-101 powder from the outlet 3 of the powder injection microchip. The optimum frequency may be affected by, for example, the particular powder in question and the size of the powder inlet orifice 10. Preferably, the piezoelectric transducer 13 is arranged to produce sound waves in the amplitude range of 1V to 10V. In this embodiment, the piezoelectric transducer 13 is arranged to produce sound waves with an amplitude of 2V. The greater the amplitude of the sound wave, the greater the degree to which the interparticle forces are overcome, increasing the extent of fluidisation of the powder. However, the greater the amplitude of the wave, the greater the volume of the sound. An amplitude of 2V represents a tolerable sound level. The ideal amplitude presents a compromise between maximising the fluidisation of the powder and minimising the volume. A mean of reducing the volume, or example using some form of insulation, would allow the use of greater amplitudes. The optimum amplitude may also be affected by, for example, the frequency of the vibrations, the cross-sectional area of the powder flow channel 2 and the particular powder in question.

A gas supply inlet 4 is arranged to provide gas with a flow rate preferably in the range of 0.1 ml.min⁻¹ to 10.0 ml.min⁻¹. In this embodiment, said gas supply inlet 4 is arranged to provide gas with a flow rate of 1.5 ml.min⁻¹. The gas pressure is regulated by a 10 cm³.min⁻¹ mass flow controller. This gas flow rate is sufficient to push the particles along without the formation of blockages. A linear relationship exists between the gas flow rate into the powder hopper 12 and the mass flow rate of powder from the outlet 3 of the microchip. Above a certain value of gas flow rate, however, the mass flow rate ceases to increase with the gas flow rate. It is possible that the size of the powder inlet orifice 10 between the powder inlet 1 and the powder flow channel 2 places an upper limit on the number of particles that may pass through the powder inlet orifice 10 per unit time. The optimum gas flow rate from gas supply inlet 4 may be affected by, for example, the cross sectional area of the powder flow channel 2, the amplitude of the vibrations of the vibratable member 7, and the particular powder in question.

The gas supply inlets 6 are arranged to provide gas with a flow rate preferably in the range of 1.0 ml.min⁻¹ to 20.0 ml.min⁻¹. In this embodiment, said gas supply inlets 6 are arranged to provide gas with a flow rate of 10 ml.min⁻¹. The gas pressure is regulated by a 100 cm³.min⁻¹ mass flow controller. Whilst the gas flow rate from gas supply inlet 4 to the powder inlet 1 has a greater impact on the mass flow rate of powder from the outlet 3, the gas flow from the gas flow channels 5 to the powder flow channel 2 does affect mass flow rate to some extent, for example because the gas flow towards the outlet 3 creates a zone of slightly lower pressure in front of the powder inlet orifice 10 and thus induces suction on particles being agitated within the powder inlet 1 and powder hopper 12. Higher velocities of gas flow would increase the strength of the suction. If the gas flow rate from gas supply inlet 4 to the powder inlet 1 is increased, the gas flow rate from the gas flow channels 5 is preferably increased to prevent more particles settling on the bottom of the powder flow channel 2, reducing the cross sectional area available for particle transport. Again, the optimum gas flow rate may be affected by, for example, the cross sectional area of the powder flow channel 2, the amplitude of the vibrations of the vibratable member 7 and the particular powder in question.

Preferably, the gas supply inlet 4 to supply gas to the powder inlet 1, and the gas supply inlets 6 to supply gas to the gas flow channels 5, are arranged to supply nitrogen. However, it will be appreciated that other gases may be suitable, including compressed air and inert gases such as argon. The most suitable gas will depend upon the properties of the powder in question.

The dimensions, and relative dimensions, and other parameters set out above may of course take other values.

The above description of an embodiment is made by way of example and not for the purposes of limitation. It will be clear to those skilled in the art that minor modifications can be made to the arrangements without significant changes to the operation described above. The vibratable member 7 may comprise a member or material other than foil. The vibratable member 7 may be positioned at any point downstream of the powder inlet orifice 10, and there may be more than one vibratable member 7. The use of other types of piezoelectric transducer may be envisaged. Sound waves of alternative frequency and amplitude may be used to create vibrations in the vibratable member 7 and overcome the interparticle forces in the cohesive powder. This method is appropriate for non-cohesive powders and cohesive powders other than those listed in the present application. The powder injection microchip may comprise any number of gas flow channels 5. The use of gases other than nitrogen, and the use of alternative gas flow rates into the powder inlet 1 and the gas flow channels 5 can be envisaged. The gas flow may be continuous or pulsed. The diameter of the powder inlet orifice 10 may be varied, in order to provide the optimum dilution of the powder flow, as dictated by the diameter of the powder flow channel 2, powder inlet 1, the gas flow rate and/or the properties of the powder, for example. The powder inlet 1 may take a variety of shapes, including an inverted cone shape. The apparatus may lack a powder hopper 12, the powder being directly introduced into the powder inlet 1. In this instance the vibratable member 7 would vibrate the powder within the powder inlet 1. The vibratable member 7, narrowed powder inlet orifice 10 and gas flow channels 5 may all be used independently of one another, or in combination, to increase the mass flow rate of a cohesive powder from a powder injection microchip.

Although specific ranges and values are provided above for a specific microchip configuration and powder type, it will be appreciated that alternative ranges and values can be adopted dependent on the microchip configuration and/or powder type desired by appropriate variation of the respective parameters taking into account the interrelationships identified above between variables.

There may be many undisclosed uses of the powder injection microchip. Further examples include the use of powder injection microchips in the ceramic and powder metallurgy industry, where solid free-forming (SFF) techniques rely on fast and accurate metering and dispensing of dry powders. The powder injection microchip and the method of its use could be used in any method where the injection of powder is required.

1. A powder injection microchip comprising a vibratable member associated with a powder inlet to a powder flow channel.

2. The apparatus as claimed in claim 1 wherein the vibratable member is positioned in operable connection with the powder inlet.

3. The apparatus as claimed in claim 1 wherein the vibratable member comprises a foil member.

4. The apparatus as claimed in claim 1 further comprising a piezoelectric transducer arranged to vibrate the vibratable member.

5. The apparatus as claimed in claim 4 wherein the piezoelectric transducer is arranged to vibrate in the frequency range of audible sound.

6. The apparatus as claimed in claim 5 wherein the piezoelectric transducer is arranged to vibrate in the range of 1.4 kHz to 1.6 kHz.

7. The apparatus as claimed in claim 6 wherein the piezoelectric transducer is arranged to vibrate at 1.5 kHz.

8. The apparatus as claimed in claim 1 wherein the powder inlet has a powder inlet orifice having a restricted powder inlet orifice dimension relative to a powder flow channel dimension.

9. The apparatus as claimed in claim 8 wherein the powder inlet orifice dimension is selected as a function of the size of the particles which comprise the powder for which the powder injection microchip is to be used.

10. The apparatus as claimed in claim 1 further comprising a gas supply in fluid connection with the powder inlet.

11. The apparatus as claimed in claim 1 further comprising at least one gas flow channel in fluid connection with the powder flow channel downstream of the powder inlet in the powder flow direction.

12. The apparatus as claimed in claim 11 wherein the gas flow channel is connected with the powder flow channel adjacent to said powder inlet.

13. The apparatus as claimed in claim 11 comprising a first and a second gas flow channel.

14. The apparatus as claimed in claim 13 wherein the gas flow channels are of substantially identical diameter.

15. The apparatus as claimed in claim 11 further comprising a gas supply in fluid connection with said gas flow channels.

16. The apparatus of claim 10 wherein the gas supplies into the powder inlet and gas flow channels are arranged to supply nitrogen.

17. The apparatus as claimed in claim 1 for use with a cohesive powder.

18. A method of injecting powder using a powder injection microchip comprising the steps of supplying the powder to a powder inlet and causing a vibratable member associated therewith to vibrate so as to fluidise the powder.

19. A method as claimed in claim 18 further comprising supplying gas to a gas flow channel downstream of the powder inlet.

20. The method as claimed in claim 18 which comprises the additional step of sieving the powder before supply to the powder inlet.

21. The method as claimed in claim 18 for use with a cohesive powder.

22. The method as claimed in claim 18 for use in powder mixing.

23. The method as claimed in claim 18 performed using an apparatus as claimed in claim 1.

24. A powder injection microchip comprising a powder inlet orifice with a dimension restrictive relative to a powder flow channel dimension and at least one gas flow channel in fluid connection with the powder flow channel, downstream of the powder inlet orifice in the powder flow direction.
